(19) United States
(12) Patent Application Publication
(10) Pub. No.: US 2020/0163281 A1
(43) Pub. Date: May 28, 2020

(54) BRAKING SYSTEM FOR HARVESTER AND METHODS OF USING THE SAME

(71) Applicant: CNH INDUSTRIAL AMERICA LLC, New Holland, PA (US)

(72) Inventors: Gregory Fasick, Hatfield, PA (US); Madhu Pankaj, West Chester, PA (US); Robert Fackler, Ephrata, PA (US); Mark Dean Layton, Lititz, PA (US)

(73) Assignee: CNH INDUSTRIAL AMERICA LLC, New Holland, PA (US)

(21) Appl. No.: 16/200,333

(22) Filed: Nov. 26, 2018

(51) Int. Cl. A01D 69/10; A01D 57/00

(52) U.S. Cl. CPC A01D 69/10; A01D 57/00

(57) ABSTRACT

The disclosure relates to a braking system useful for providing stable braking of harvesters, such as self-propelled windrowers. The braking system utilizes respective service brakes associated with or integrated into a front drive system of the harvester, each of the service brakes configured to slow down or stop rotation of the respective front wheels. A controller/module is configured to receive inputs and feedback parameters to actuate components of the harvester to slow down or stop the harvester.

### BACKGROUND

Harvesters such as windrowers, tractors, and forage harvesters, have to operate effectively and safely in normal and high-speed modes. Typical construction for such vehicles include front ground wheels mounted on the frame at fixed angles parallel to each other and parallel to a center line of the frame, and rear ground wheels mounted on a respective caster. Each of the front ground wheels is typically driven by a respective drive motor which allows variable speed in both the forward and reverse directions such that steering of the tractor is effected by a differential in speed between the front wheels with the rear wheels following the steering in a castering action.

The speed at which conventional harvesters travel has increased over time with technological developments in the industry. Additionally, conventional harvesters have increased in weight due to an increase in the header size used and a push for larger field coverage during each pass. Aggressive stopping distance standards and the movement from mechanical steering control to fully electronic steering control has also affected operation of conventional harvesters. Such changes and improvements to conventional harvesters has resulted in potential difficulties encountered when stopping the harvester, particularly during high-speed operation.

FIG. 1 shows a perspective view of a conventional windrower 10. The windrower 10 generally includes front wheels 12, 14 rotatably mounted to a frame 16. The windrower 10 includes a cabin 18 configured and dimensioned to receive an operator, and having a plurality of controls for operation of the windrower 10, such as controlling a header 20 attachable to the front 22 of the windrower 10, controlling movement of the windrower 10 in a forward direction 24, and controlling movement of the windrower 10 in a reverse direction 26. Typically, the windrower 10 uses a mechanical hydraulic steering valve for steering the windrower 10.

At the rear 28, the windrower 10 includes casters 30, 32 rotatably mounted on opposing sides of a rear axle 34 which, in turn, is coupled to the frame 16. In some instances, a damping system (e.g., passive dampers, active dampers, or the like) can be mounted to the rear axle 34 for one or both of the casters 30, 32. The windrower 10 includes two independent caster wheels 36, 38 mounted to the respective casters 32, 34, one on the left-hand side and one on the right-hand side of the windrower 10. As noted above, during normal, reverse and high-speed operation modes, difficultly in stopping or slowing down the windrower 10 can be encountered.

### SUMMARY

The disclosure relates to braking system for a harvester that assists in braking the harvester in situations where traditional braking systems are insufficient to achieve the desired result. In some embodiments, the disclosed braking system can be used as an alternative and primary system for braking the harvester. The braking system includes service brakes on one or both of the front drive wheels of the harvester, assisting in stopping or slowing the harvester, thereby meeting braking distance standards, preventing engine and/or hydraulic pump over-speed, and assisting in safely bringing the harvester to a stop during a fault or failure in the propulsion or steering functions.

In accordance with some embodiments of the present disclosure, an exemplary braking system for a harvester is provided. The braking system comprises a first service brake associated with or integrated into a front drive system of the harvester and configured to slow down or stop rotation of a first front wheel of the harvester. The braking system comprises a second service brake associated with or integrated into the front drive system of the harvester and configured to slow down or stop rotation of a second front wheel of the harvester. The braking system comprises a controller/module configured to receive one or more inputs and one or more feedback parameters associated with the harvester, and output actuation of one or more components of the harvester to slow down or stop the harvester.

In some embodiments, the one or more inputs comprise a requested deceleration rate of the harvester and a mechanical and/or electronic steering input position. In some embodiments, the one or more inputs comprise an applied brake (e.g., brake pedal, brake button, MFH handle, FNR handle, combinations thereof, or the like) or a steering input position. In some embodiments, the one or more feedback parameters comprise at least one of an engine speed, a first front wheel speed, a second front wheel speed, a first front wheel pump/motor reverse drive pressure, a second front wheel pump/motor reverse drive pressure, a first front wheel pump swash plate position, and a second front wheel pump swash plate position. In such embodiments, the controller/module is configured to actuate a hydraulic pump and motor control to adjust displacement of at least one of a first front wheel drive pump, a second front wheel drive pump, a first front wheel drive motor, and a second front wheel drive motor, to brake and steer the harvester.

In some embodiments, the one or more feedback parameters comprise an engine speed. In such embodiments, the controller/module is configured to actuate an engine flapper valve to reduce the engine speed. Actuation of the engine flapper valve comprises varying a position of the engine flapper valve between a fully on position and a fully off position.

In some embodiments, the one or more feedback parameters comprise at least one of a first front wheel speed and a second front wheel speed. In such embodiments, the output of the controller/module comprises actuation of a service brake control system to brake the harvester. Actuation of the service brake control system comprises control of at least a first front wheel hydraulic proportional pressure valve and a second front wheel hydraulic proportional pressure valve to proportionally vary a service brake force from zero to a maximum braking force.

In some embodiments, the service brake force is equal for the first and second service brakes. In some embodiments, the service brake force is different for the first and second service brakes. In some embodiments, the service brake force for the first and second service brakes is continuously adjusted together. In some embodiments, the service brake force for the first and second service brakes is independently adjusted.

In accordance with embodiments of the present disclosure, an exemplary harvester is provided. The harvester comprises a frame, first and second front wheels pivotally mounted to the frame at a front of the harvester, first and second casters pivotally mounted to the frame at a rear of the harvester, and a braking system. The braking system comprises a first service brake associated with or integrated into a front drive system of the harvester and configured to slow down or stop rotation of the first front wheel. The braking system comprises a second service brake associated with or integrated into the front drive system of the harvester and configured to slow down or stop rotation of the second front wheel. The braking system comprises a controller/module configured to receive one or more inputs and one or more feedback parameters associated with the harvester, and output actuation of one or more components of the harvester to slow down or stop the harvester.

In some embodiments, the one or more feedback parameters comprise at least one of a first front wheel speed and a second front wheel speed. In such embodiments, the output of the controller/module comprises actuation of a service brake control system to brake the harvester. Actuation of the service brake control system comprises control of at least a first front wheel hydraulic proportional pressure valve and a second front wheel hydraulic proportional pressure valve to proportionally vary a service brake force from zero to a maximum braking force.

In accordance with embodiments of the present disclosure, an exemplary braking system for a harvester is provided. The braking system comprises a first service brake associated with or integrated into a front drive system of the harvester and configured to slow down or stop rotation of a first front wheel of the harvester. The braking system comprises a second service brake associated with or integrated into the front drive system of the harvester and configured to slow down or stop rotation of a second front wheel of the harvester. The braking system comprises a controller/module configured to receive one or more inputs and one or more feedback parameters associated with the harvester, and output actuation of one or more components of the harvester to slow down or stop the harvester. The one or more feedback parameters comprise a first front wheel speed and a second front wheel speed. The output of the controller/module comprises control of at least a first front wheel hydraulic proportional pressure valve and a second front wheel hydraulic proportional pressure valve to proportionally vary a service brake force from zero to a maximum braking force.

In accordance with embodiments of the present disclosure, an exemplary method of operating a braking system for a harvester is provided. The method comprises providing a first service brake associated with or integrated into a front drive system of the harvester and configured to slow down or stop rotation of a first front wheel of the harvester, and providing a second service brake associated with or integrated into the front drive system of the harvester and configured to slow down or stop rotation of a second front wheel of the harvester. The method comprises receiving one or more inputs and one or more feedback parameters associated with the harvester at a controller/module. The method comprises outputting actuation of one or more components of the harvester based on the one or more inputs and the one or more feedback parameters to slow down or stop the harvester.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed braking systems, reference is made to the accompanying figures, wherein:

FIG. 1 is a perspective view of a conventional windrower;

FIG. 2 is a block diagram of an exemplary harvester of the present disclosure;

FIG. 3 is a block diagram of an exemplary braking system of a harvester of the present disclosure;

FIG. 4 is a block diagram of an exemplary braking system of a harvester of the present disclosure;

FIG. 5 is a block diagram of an exemplary braking system of a harvester of the present disclosure; and

FIG. 6 is a block diagram of an exemplary braking system of a harvester of the present disclosure.

### DETAILED DESCRIPTION

Various terms relating to the methods and other aspects of the present disclosure are used throughout the specification and claims. Such terms are to be given their ordinary meaning in the art unless otherwise indicated. Other specifically defined terms are to be construed in a manner consistent with the definition provided herein.

As used in this specification and the appended claims, the singular forms “a,” “an,” and “the” include plural referents unless the content clearly dictates otherwise.

The term “more than 2” as used herein is defined as any whole integer greater than the number two, e.g., 3, 4, or 5.

The term “plurality” as used herein is defined as any amount or number greater or more than 1. In some embodiments, the term “plurality” means 2, 3, 4, 5, 6 or more.

The terms “left” or “right” are used herein as a matter of mere convenience, and are determined by standing at the rear of the machine facing in its normal direction of travel. Likewise, “forward” and “rearward” are determined by the normal direction of travel. “Upward” and “downward” orientations are relative to the ground or operating surface as are any references to “horizontal” or “vertical” planes.

The term “about” as used herein when referring to a measurable value such as an amount, a temporal duration, and the like, is meant to encompass variations of ±20%, ±10%, ±5%, ±1%, ±0.5%, ±0.4%, ±0.3%, ±0.2%, ±0.1%, ±0.09%, ±0.08%, ±0.07%, ±0.06%, ±0.05%, ±0.04%, ±0.03%, ±0.02% or ±0.01% from the specified value, as such variations are appropriate to perform the disclosed methods.

The term “harvester” as used herein is defined as a machine that consolidates and/or packages material so as to facilitate the storage and handling of the material for later use. In some embodiments, the harvester is used to harvest agricultural material. In some embodiments, the harvester is a windrower, a forage harvester, lawn mower or a combine including a baling mechanism. In some embodiments, the harvester is a self-propelled windrower.

The term “material” as used herein is defined as a numerous individual items that are harvested or collected by the harvester. In some embodiments, the material is agricultural crop, such as hay or silage. In some embodiments, the material is biomass.

The term “drive system” or “steering system” as used herein is defined as an assembly, hydraulic or mechanical arrangement that allows for control of the front and/or rear wheels of the harvester.

The term “information” as used herein is defined as data values attributed to parameters. In some embodiments, information is digital and/or analog information. In some embodiments, information is the current operable mode of the harvester. In some embodiments, warning information can be audio and/or visual information. In some embodiments, warning information is information that is capable of alerting an operator that an action may need to be taken.

Discussions herein utilizing terms such as, for example, “processing,” “computing,” “calculating,” “determining,” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, or harvester. In some embodiments, the harvester includes a software system with executable code that executes different hydraulic states based on operator control of the harvester. In some embodiments, the disclosure also relates to a computer software product with executable code that automatically toggles between or through different hydraulic states based on operator control of the harvester. The software program product may be on any medium or a component of a system optionally configured for update or install into the software of an existing harvester.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, the disclosure relates to a processing system including a processing device suitable for storing and/or executing program code and may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. In some embodiments, the memory is capable of storing preferred settings or information about operation of the harvester. In some embodiments, the system includes one or a plurality of sensors to detect the operation selected by the operator. The sensors may be hard wired to one or more wires creating a physical connection to one or a plurality of controllers and/or are active sensors can be activated and used over a WiFi hotspot, Bluetooth® or other internet connection with controllers capable of receiving such remote signals.

In some embodiments, input/output or I/O devices (including but not limited to keyboards, displays, pointing devices, etc.) may be coupled to the system either directly or through intervening I/O controllers. In some embodiments, I/O devices may be coupled to the system directly or to I/O controller by an I/O bus (cables and or wires which connect the devices and enable the information to pass therebetween). In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used. Any sensor disclosed herein may function on any disclosed harvester by integration into one or more data processing systems of the harvester. For example, in some embodiments, the disclosure relates to a data processing system including executable software program product configured for sending and receiving information about the operation of the harvester.

The term “real-time” and the phrase “in real-time” as used herein are defined as a way of describing a process, event, or action that occurs simultaneously with the process of actively operating a harvester. In some embodiments, various sensors continuously sense information about operation of the harvester and transmit that information to a controller in real-time. In some embodiments, an operator may adjust values or thresholds for one or more operation states in real-time through the operator interface by accessing the system electronically and inputting one or a plurality of values.

Many of the fastening, connection, processes and other means and components utilized in this disclosure are widely known and used in the field of the disclosure described, and their exact nature or type is not necessary for an understanding and use of the disclosure by a person skilled in the art, and they will not therefore be discussed in significant detail. Furthermore, the various components shown or described herein for any specific application of this disclosure can be varied and the practice of a specific application of any element may already be widely known or used in the art by persons skilled in the art and each will likewise not therefore be discussed in significant detail.

Windrowers and tractors, such as self-propelled windrowers, are well known in the agricultural industry, and the instant invention can be used with substantially any of such machines. Reference is made, for example, to U.S. Pat. Nos. 9,101,090 and 8,020,648; that illustrate such windrowers, the disclosures of which are incorporated herein by reference in their entireties. Embodiments of the present invention are particularly well suited, but in no way limited to, use with windrowers. The present invention may also find utility in agricultural harvesters including, for example, a self-propelled windrower, a forage harvester, cotton harvester or a lawn mower. Embodiments of the present disclosure are particularly well suited, but in no way limited to, use with any vehicle with a front and rear steer system.

In some embodiments, the method is performed by a harvester comprising a crop supply chamber, a crop gating system, and one or more sensors. In some embodiments, the one or more sensors are capable of determining a range of information, including, but not limited to, one or a combination of: the size of a bale in the bale chamber (diameter and/or weight), the position of the tailgate, the position of the control arm, the position of the rear wall, and the position of the crop gating system. In some embodiments, the one or more sensors are in electronic communication with one or more controllers. In some embodiments, sensors can be used to determine that the position of the casters.

The exemplary harvester (e.g., windrower) discussed herein includes two hydraulic pumps and motors for dual path control of both propulsion and steering functions of the harvester. Service brakes are disposed on or associated with each of the front drive wheels. The service brakes can either be integrated into or be added onto the final drive system to which the wheels and tires are mounted. The service brakes can be controlled by a pedal (e.g., applied brake) or similar device in the cab by the operator or can be controlled by the rate at which the MFH or FNR handle is reduced (e.g., reduce speed). Any of the braking systems discussed herein can be incorporated into the harvester.

In operation of the braking systems, an electronic software controller/module can be used to control the braking of the harvester. As used herein, the term braking can be defined as any time the speed of the harvester is decreased either as activated by the operator or when a fault is detected in the propulsion or steering control for which the harvester is required to be safely brought to a stop. The inputs to the control logic can be the FNR/MFH lever (requested rate of movement or deceleration), the electronic brake pedal or other operator activated device, and/or the steering input device (e.g., steering wheel and requested steering angle).

Feedback parameters of the system can also be used as input to the control logic (e.g., at the controller/module). For example, feedback of the engine speed, LH and RH wheel speeds, and hydraulic loop pressures as measured by sensors of the harvester can be used as input to the control logic performed by the controller/module. Software control can be used to monitor the feedback parameters during a braking event while controlling any combination of or all of, e.g., the braking controls, hydraulic pump and motor control of machine braking (hydro braking), engine exhaust valve (flapper valve) for machine braking, service brake application for machine braking, or the like.

While monitoring the any or all of the feedback parameters and trying to achieve the requested machine braking, the braking controls can be continuously adjusted together or independently to adjust the rate of braking force applied to the system in a closed loop software control process. For example, the exhaust or engine flapper valve can be fully off or on, or proportionally controlled somewhere in-between. In some embodiments, the service brake pressure can be proportionally controlled to the amount of service brake engagement or force applied. In some embodiments, the service brakes can be applied equally left and right, or independently at different rates, to provide additional steering of the harvester by reducing the LH and RH wheel speeds at different rates, thereby creating a torque differential resulting in the harvester turning. While using the steering input device position, the service brakes can be automatically applied independently to create a wheel speed differential to steer the harvester in the event of a failure of the pump and motor steering control.

The exemplary harvester and braking system discussed herein allows for increased or improved stopping distances. Faster machine travel speeds are possible, reduced engine, gearbox and pump over-speed amounts during braking can also be achieved. Independent proportional control of the wheel speeds via the service brakes in the event of hydraulic pump and motor failure allows for improved control of the harvester. Proportional control of the engine flapper or exhaust valve can also be achieved with the exemplary braking systems. Thus, service brakes can be used in conjunction with control of the pump, motor and/or engine flapper valve to control braking of the windrower. The steering input device position can also be monitored and used to proportionally apply and control the service brakes for stopping the windrower in a fault or failure of the primary drive (e.g., hydraulic pump and motor failure).

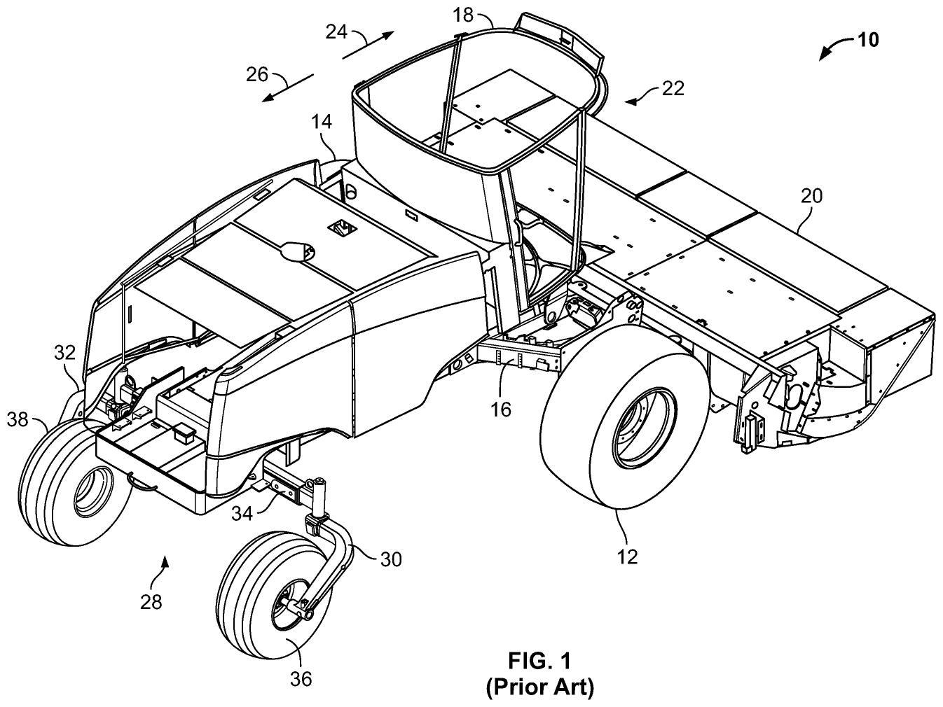

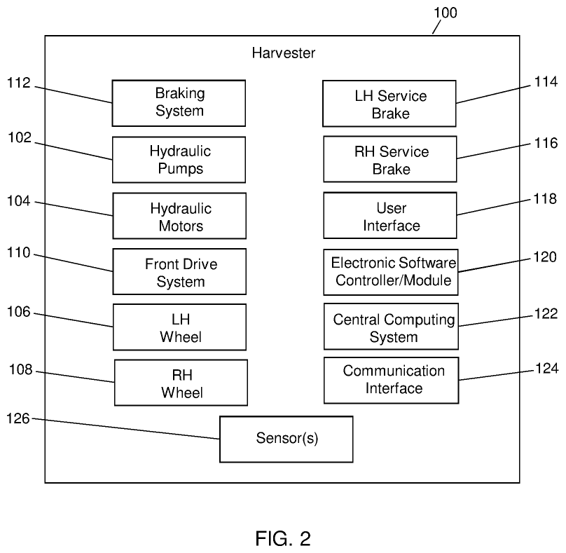

FIG. 2 shows a block diagram of an exemplary harvester 100 of the present disclosure. The harvester 100 includes one or more hydraulic pumps 102 and one or more motors 104 for dual path control of both propulsion and steering functions of the harvester 100. The harvester 100 includes a left-hand (LH) wheel 106 and a right-hand (RH) wheel 108 (e.g., front wheels of the harvester 100 similar to wheels 12, 14 of FIG. 1) mounted to the frame of the harvester 100. The harvester 100 includes a front drive system 110 associated with the wheels 106, 108, driving the wheels 106, 108 to allow for movement of the harvester 100.

The harvester 100 includes a braking system 112 (e.g., one of the braking systems 200-500 discussed herein) for regulating slowing down and/or stopping of the harvester 100. The harvester 100 includes a LH service brake 114 associated with the LH wheel 106 and a RH service brake 116 associated with the RH wheel 108 (and/or the front drive system 110). The service brakes 114, 116 can be selectively controlled to slow down and/or stop the harvester 100. Although shows as separate components from the braking system 112, it should be understood that the service brakes 114, 116 can structurally be considered as part of the braking system 112.

The harvester 100 can include a user interface 118 (e.g., a graphical user interface) within the cab. The user interface 118 allows for information, commands and/or data to be input into the harvester 100, and provides feedback (e.g., visual, audio, combinations thereof, or the like) to the operator of the harvester 100. The harvester 100 can include an electronic software controller/module 120 (e.g., a processing device) configured to receive data and/or instructions as input and control operation of one or more features of the harvester 100. For example, the controller/module 120 can be used to regulate operation of the braking system 112, the hydraulic pumps 102, the hydraulic motors 104, the front drive system 110, the service brakes 114, 116, or the like.

The harvester 100 can include a central computing system 122 configured to oversee operation of the harvester 100. In some embodiments, the controller/module 120 can be integrated into the central computing system 122. The harvester 100 can include a communication interface 124 configured to provide for transmitting and/or receiving of data between one or more features of the harvester 100. The harvester 100 can include one or more sensors 126 disposed at various locations of the harvester 100. Each of the sensors 126 can be configured to detect or measure characteristics associated with features of the harvester 100, and communicate the characteristics to the braking system 112, controller/module 120, central computing system 122, or the like.

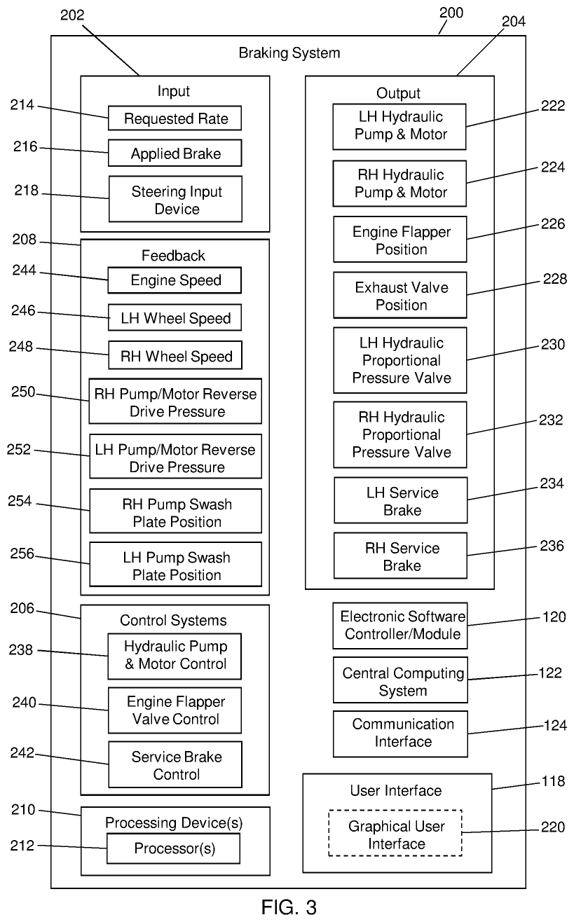

FIG. 3 shows a block diagram of one embodiment of a braking system 200 of the harvester 100. The braking system 200 can receive one or more inputs 202, regulates one or more outputs 204 via control systems 206, and receives feedback 208 for measuring and improving the effectiveness of the output control logic. Each of the inputs 202, outputs 204, control systems 206 and feedback 208 can be in communication with the controller/module 120. In some embodiments, the inputs 202 can be measured from the harvester 100 operator and electronically transmitted to the controller/module 120 via the communication interface 124 for processing.

In some embodiments, a processing device 210 having one or more processors 212 can be integrated into or associated with the controller/module 120 to analyze and process the inputs 202. The controller/module 120 can use one or all of the outputs 204 received by the controlled/module 120 to achieve the inputs 202, while monitoring and preventing engine over-speed. The feedback 208 can be used to continuously adjust the output control logic to achieve effective, efficient and accurate control of the harvester 100.

The input 202 can include one or more of a requested rate 214 (e.g., a deceleration rate), an applied brake 216, and/or a mechanical and/or electronic steering input device 218 (e.g., a steering wheel, joystick, or the like). The requested rate 214 can correspond with the desired speed of the harvester 100 or deceleration of the harvester 100 based on movement or actuation of a multi-function handle (MFH) or front, neutral, reverse (FNR) lever, or data input into the user interface 118. In some embodiments, the user interface 118 can include a graphical user interface 220 for input of the requested rate 214 or any other input data. The applied brake 216 can correspond with actuation with an electronic service brake pedal or any other operator applied braking device (and sensor data transmitted based on such actuation). In some embodiments, the applied brake 216 can correspond with actuation of, e.g., a brake pedal, a brake button, a MFH handle, a FNR handle, combinations thereof, or the like. The steering input device 218 can correspond with sensor data representative of the rotational position of a steering device during operation of the harvester 100.

The output 204 can include control of one or more of, e.g., a LH hydraulic pump and motor 222, a RH hydraulic pump and motor 224, an engine flapper position 226, an exhaust valve position 228, a LH hydraulic proportional pressure valve 230, a RH hydraulic proportional pressure valve 232, a LH service brake 234, a RH service brake 236, combinations thereof, or the like. The engine flapper position 226 and the exhaust valve position 228 can be the variable position (e.g., percent negative torque) of the flapper and/or valve. Actuation or control of the LH hydraulic proportional pressure valve 230 can actuate or control operation of the LH service brake 234. Similarly, actuation or control of the RH hydraulic proportional pressure valve 232 can actuate or control operation of the RH service brake 236.

The control systems 206 can include a hydraulic pump and motor control 238, an engine flapper valve control 240, and a service brake control 242. The hydraulic pump and motor control 238 can be used for machine braking and steering, thereby actuating and/or controlling the LH and RH hydraulic pump and motors 222, 224. The engine flapper valve control 240 (e.g., exhaust brake) can be used to control machine braking, thereby actuating and/or controlling the engine flapper or exhaust valve positions 226, 228. The service brake control 242 can be used for machine braking, thereby actuating and/or controlling the LH and RH hydraulic proportional pressure valves 230, 232 which, in turn, actuate and/or control the LH and RH service brakes 234, 236.

The feedback 208 can include one or more of, e.g., engine speed 244, LH wheel speed 246, RH wheel speed 248, RH pump/motor reverse drive pressure 250, LH pump/motor reverse drive pressure 252, RH pump swash plate position 254, LH pump swash plate position 256, combinations thereof, or the like. The feedback 208 can be provided via one or more sensors disposed within the harvester 100. For example, the engine of the harvester 100 can include a sensor configured to detect the speed. As a further example, each of the wheels can include a sensor configured to detect the rotational speed of the respective wheels. The detected or measured data can be electronically transmitted to the braking system 200 substantially in real-time.

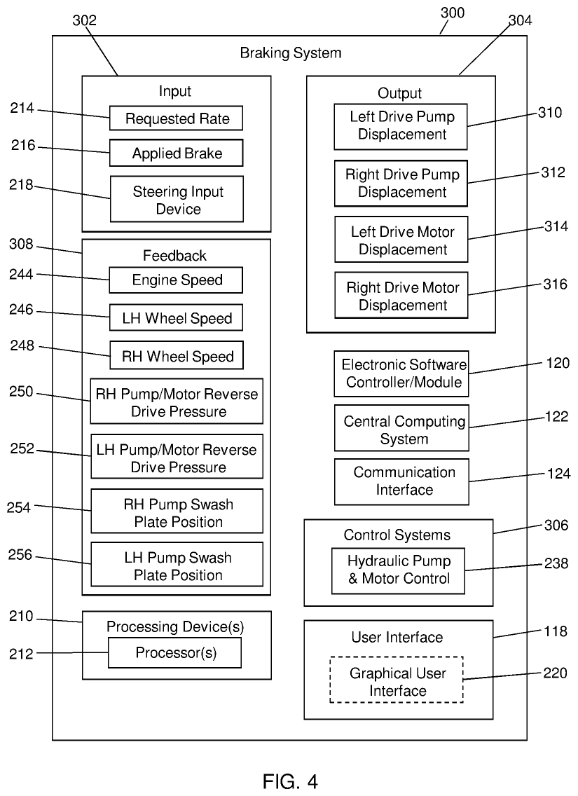

FIG. 4 shows a block diagram of another embodiment of a braking system 300 of the harvester 100. Certain features of the braking system 300 can be substantially similar in structure and function to the braking system 200. Therefore, like reference numbers refer to similar components. The braking system 300 includes one or more inputs 302, one or more outputs 304, one or more control systems 306, and feedback 308. The inputs 302 can include one or more of the requested rate 214, the applied brake 216, and/or the steering input device 218.

The outputs 304 can include one or more of, e.g., a left drive pump displacement 310, a right drive pump displacement 312, a left drive motor displacement 314, a right drive motor displacement 316, combinations thereof, or the like. The outputs 304 can represent adjustments of the respective pump and motor displacements as controlled by the harvester 100. The control systems 306 can include hydraulic pump and motor control 238 for machine braking and steering. The control systems 306 can actuate or control each of the outputs 304.

The feedback 308 can include one or more of, e.g., engine speed 244, LH wheel speed 246, RH wheel speed 248, RH pump/motor reverse drive pressure 250, LH pump/motor reverse drive pressure 252, RH pump swash plate position 254, LH pump swash plate position 256, combinations thereof, or the like. The hydraulic pump and motor can be controlled by the braking system 300 to change the displacements of the pump and/or motor to brake and steer the harvester 100. One or more of the feedback 308 can be used to assist in adjusting the displacements to achieve the inputs 302 received from the operator.

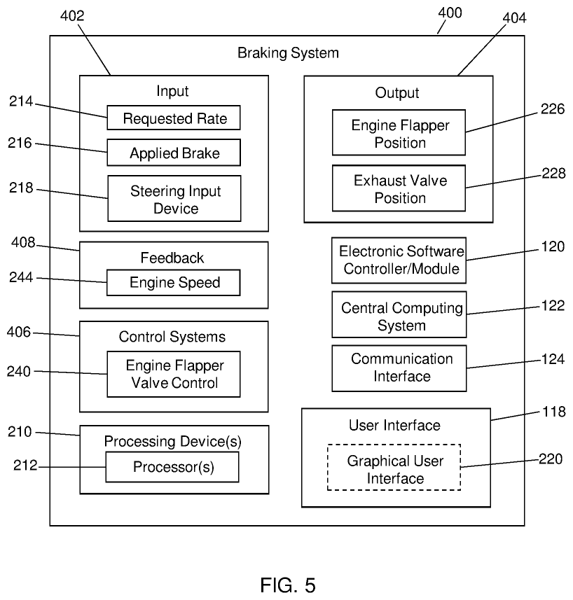

FIG. 5 shows a block diagram of another embodiment of a braking system 400 of the harvester 100. Certain features of the braking system 400 can be substantially similar in structure and function to the braking system 200. Therefore, like reference numbers refer to similar components. The braking system 400 includes one or more inputs 402, one or more outputs 404, one or more control systems 406, and feedback 408. The inputs 402 can include one or more of the requested rate 214, the applied brake 216, and/or the steering input device 218.

The outputs 404 can include one or more of, e.g., the engine flapper position 226, the exhaust valve position 228, combinations thereof, or the like. The engine flapper position 226 and/or the exhaust valve position 228 can represent an adjustment of a position of the engine flapper or exhaust valve in percent negative torque. The control systems 406 can include the engine flapper valve control 240 for machine braking. The control systems 406 can directly actuate or control the outputs 404.

The feedback 408 can include the engine speed 244. The engine flapper vale or the exhaust brake can be variably controlled from a fully ON to a fully OFF position, or anywhere in-between, to reduce the engine speed to prevent engine over-speed during a braking event. Such operation can be achieved by varying the percent negative torque of the engine, thereby reducing engine speed that could otherwise increase during the braking event.

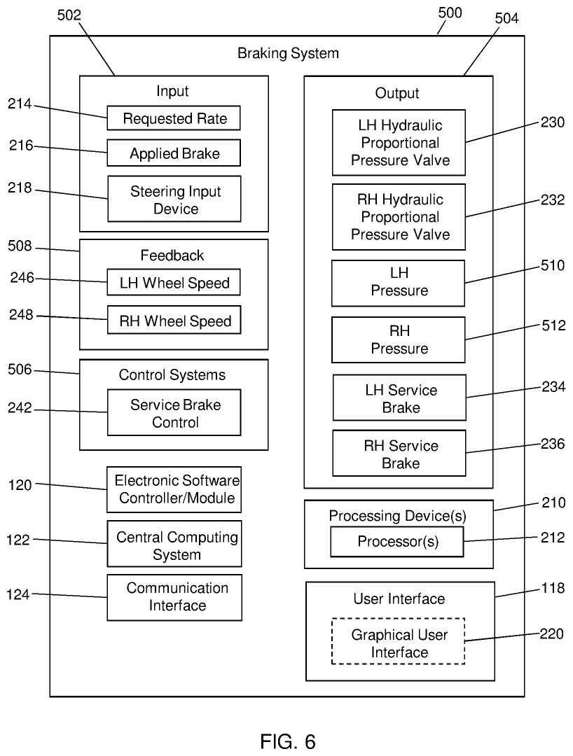

FIG. 6 shows a block diagram of another embodiment of a braking system 500 of the harvester 100. Certain features of the braking system 500 can be substantially similar in structure and function to the braking system 200. Therefore, like reference numbers refer to similar components. The braking system 500 includes one or more inputs 502, one or more outputs 504, one or more control systems 506, and feedback 508. The inputs 502 can include one or more of the requested rate 214, the applied brake 216, and/or the steering input device 218.

The outputs 504 can include one or more of, e.g., the LH hydraulic proportional pressure valve 230, the RH hydraulic proportional pressure valve 232, LH pressure 510, RH pressure 512, LH service brake 234, RH service brake 236, combinations thereof, or the like. The control systems 506 can include the service brake control 242 for machine braking. The control systems 506 can actuate or control the LH and RH hydraulic proportional pressure valves 230, 232 which, in turn, actuates or controls the respective LH and RH pressure 510, 512. The LH and RH pressure 510, 512 can be commanded based on the amount of service brake force applied (from zero to maximum). The LH and RH pressure 510, 512, in turn, actuate the respective LH and RH service brake 234, 236 application.

The feedback 508 can include one or more of, e.g., the LH wheel speed 246, the RH wheel speed 248, combinations thereof, or the like. The service brake force applied can be proportionally varied from zero to maximum braking force by using the proportional valves to control application of pressure to the brake actuating device. The LH and RH pressures and forces can be equal or varied. The braking force can be used to assist in slowing the harvester 100 and wheel speeds can be monitored for feedback to ensure the target wheel speeds are achieved.

While exemplary embodiments have been described herein, it is expressly noted that these embodiments should not be construed as limiting, but rather that additions and modifications to what is expressly described herein also are included within the scope of the present disclosure. Moreover, it is to be understood that the features of the various embodiments described herein are not mutually exclusive and can exist in various combinations and permutations, even if such combinations or permutations are not made express herein, without departing from the spirit and scope of the present disclosure.

1. A braking system for a harvester, comprising:
a first service brake associated with or integrated into a front drive system of the harvester and configured to slow down or stop rotation of a first front wheel of the harvester;
a second service brake associated with or integrated into the front drive system of the harvester and configured to slow down or stop rotation of a second front wheel of the harvester; and
a controller/module configured to receive one or more inputs and one or more feedback parameters associated with the harvester, and output actuation of one or more components of the harvester to slow down or stop the harvester.

2. The braking system of claim 1, wherein the one or more inputs comprise a requested deceleration rate of the harvester and a steering input position.

3. The braking system of claim 1, wherein the one or more inputs comprise an applied brake or a steering input position.

4. The braking system of claim 1, wherein the one or more feedback parameters comprise at least one of an engine speed, a first front wheel speed, a second front wheel speed, a first front wheel pump/motor reverse drive pressure, a second front wheel pump/motor reverse drive pressure, a first front wheel pump swash plate position, and a second front wheel pump swash plate position.

5. The braking system of claim 4, wherein the controller/module is configured to actuate a hydraulic pump and motor control to adjust displacement of at least one of a first front wheel drive pump, a second front wheel drive pump, a first front wheel drive motor, and a second front wheel drive motor, to brake and steer the harvester.

6. The braking system of claim 1, wherein the one or more feedback parameters comprise an engine speed.

7. The braking system of claim 6, wherein the controller/module is configured to actuate an engine flapper valve to reduce the engine speed.

8. The braking system of claim 7, wherein actuation of the engine flapper valve comprises varying a position of the engine flapper valve between a fully on position and a fully off position.

9. The braking system of claim 1, wherein the one or more feedback parameters comprise at least one of a first front wheel speed and a second front wheel speed.

10. The braking system of claim 9, wherein the output of the controller/module comprises actuation of a service brake control system to brake the harvester.

11. The braking system of claim 10, wherein actuation of the service brake control system comprises control of at least a first front wheel hydraulic proportional pressure valve and a second front wheel hydraulic proportional pressure valve to proportionally vary a service brake force from zero to a maximum braking force.

12. The braking system of claim 11, wherein the service brake force is equal for the first and second service brakes.

13. The braking system of claim 11, wherein the service brake force is different for the first and second service brakes.

14. The braking system of claim 11, wherein the service brake force for the first and second service brakes is continuously adjusted together.

15. The braking system of claim 11, wherein the service brake force for the first and second service brakes is independently adjusted.

16. A harvester, comprising:
a frame;
first and second front wheels pivotally mounted to the frame at a front of the harvester;
first and second casters pivotally mounted to the frame at a rear of the harvester; and
a braking system comprising:
a first service brake associated with or integrated into a front drive system of the harvester and configured to slow down or stop rotation of the first front wheel;
a second service brake associated with or integrated into the front drive system of the harvester and configured to slow down or stop rotation of the second front wheel; and
a controller/module configured to receive one or more inputs and one or more feedback parameters associated with the harvester, and output actuation of one or more components of the harvester to slow down or stop the harvester.

17. The harvester of claim 16, wherein the one or more feedback parameters comprise at least one of a first front wheel speed and a second front wheel speed.

18. The harvester of claim 17, wherein the output of the controller/module comprises actuation of a service brake control system to brake the harvester.

19. The harvester of claim 18, wherein actuation of the service brake control system comprises control of at least a first front wheel hydraulic proportional pressure valve and a second front wheel hydraulic proportional pressure valve to proportionally vary a service brake force from zero to a maximum braking force.

20. A braking system for a harvester, comprising:
a first service brake associated with or integrated into a front drive system of the harvester and configured to slow down or stop rotation of a first front wheel of the harvester;
a second service brake associated with or integrated into the front drive system of the harvester and configured to slow down or stop rotation of a second front wheel of the harvester; and
a controller/module configured to receive one or more inputs and one or more feedback parameters associated with the harvester, and output actuation of one or more components of the harvester to slow down or stop the harvester,
wherein the one or more feedback parameters comprise a first front wheel speed and a second front wheel speed, and
wherein the output of the controller/module comprises control of at least a first front wheel hydraulic proportional pressure valve and a second front wheel hydraulic proportional pressure valve to proportionally vary a service brake force from zero to a maximum braking force.
